(19) United States
(12) Patent Application Publication
(10) Pub. No.: US 2025/0296370 A1
(43) Pub. Date: Sep. 25, 2025

(54) PRINTER

(71) Applicant: TOSHIBA TEC KABUSHIKI KAISHA, Tokyo (JP)

(72) Inventor: Yuji Kawamorita, Mishima Shizuoka (JP)

(21) Appl. No.: 19/049,177

(22) Filed: Feb. 10, 2025

(30) Foreign Application Priority Data
Mar. 21, 2024 (JP) 2024-045225

(51) Int. Cl. B41J 15/04; B65H 7/04

(52) U.S. Cl. CPC B41J 15/04; B65H 7/04; B65H 2801/03

(57) ABSTRACT

According to one embodiment, a printer includes a holder unit configured to hold a roll of paper with a rolled belt-like sheet, a conveyance unit configured to pull out the sheet from the holder unit, and a keeping unit provided between the holder unit and the conveyance unit and configured to keep an angle of a separation edge between a cylindrical outer circumferential surface of the roll of paper and the sheet pulled out from the roll of paper at a predetermined acute angle.

### CROSS-REFERENCE TO RELATED APPLICATION

This application is based upon and claims the benefit of priority from Japanese Patent Application No. 2024-045225, filed on Mar. 21, 2024, the entire contents of which are incorporated herein by reference.

### FIELD

Embodiments described herein relate generally to a printer.

### BACKGROUND

In related art, in a printer, if the sheet conveyance condition is disturbed, the printing condition is disturbed. In order to stabilize printing quality, it is necessary to stabilize the sheet conveyance condition. Particularly, in a printer using a roll of paper with a rolled belt-like sheet, printing is performed while the sheet is pulled out from the roll of paper. Accordingly, the printer is configured to prevent fluctuations of a force necessary for conveyance (conveyance force) at the start of rotation of the roll of paper or the like from affecting printing by provision of a damper in a conveyance path of the sheet or the like.

However, for example, if the roll of paper is a roll of linerless labels, the conveyance force for pulling out the sheet is also dependent on fluctuations of a force for peeling the labels, and the printing quality tends to be significantly affected. This is more significant if a holder unit holding the roll of paper is of the so-called drop-in type. Further, this is even more significant if the sheets supported by the printer are not of a single type or have various widths.

### DESCRIPTION OF THE DRAWINGS

FIG. 1 is a perspective view showing an example of an appearance of a printer of an embodiment.

FIG. 2 is a sectional view showing an example of an internal structure of the printer.

FIG. 3 is a sectional view showing the printer with a lid unit open.

FIG. 4 is a perspective view showing the printer with the lid unit open.

FIG. 5 is a diagram for explanation of a relation between a peeling edge of a sheet from a roll of paper and a keeping unit.

### DETAILED DESCRIPTION

A challenge to be solved by the present disclosure is to provide stability of sheet conveyance and printing quality in a printer that prints on a sheet pulled out from a roll of paper.

In general, according to one embodiment, a printer includes a holder unit configured to hold a roll of paper with a rolled belt-like sheet, a conveyance unit configured to pull out the sheet from the holder unit, and a keeping unit provided between the holder unit and the conveyance unit and configured to keep an angle of a separation edge between a cylindrical outer circumferential surface of the roll of paper and the sheet pulled out from the roll of paper at a predetermined acute angle. According to another embodiment, a method for a printer involves holding a roll of paper with a rolled belt-like sheet on a holder;
pulling out the sheet from the holder using a conveyance component; and keeping an angle of a separation edge between a cylindrical outer circumferential surface of the roll of paper and the sheet pulled out from the roll of paper at a predetermined acute angle.

### First Embodiment

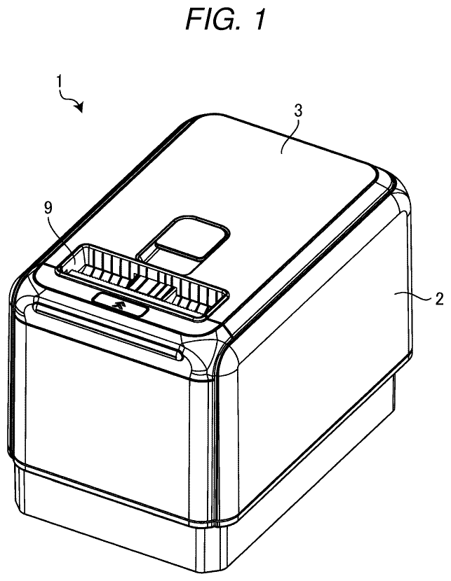

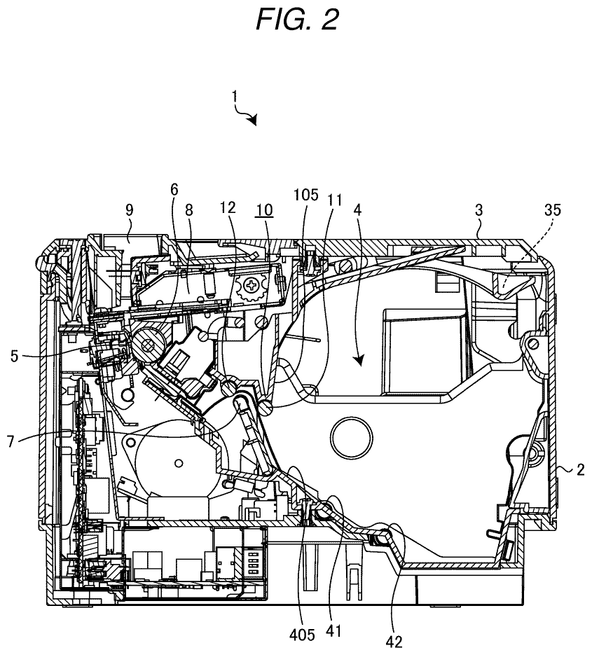

An embodiment will be explained using the drawings. FIG. 1 is a perspective view showing an example of an appearance of a printer 1 of the embodiment. In the perspective view of FIG. 1, an upper surface, a front surface, and a right side surface of the printer 1 are seen and a bottom surface, a back surface, and a left side surface of the printer 1 are not seen. FIG. 2 is a sectional view showing an example of an internal structure of the printer 1.

The printer 1 includes a housing 2, a lid unit 3, a holder unit 4, a printing head 5, a platen roller 6, a damper 7, a cutter unit 8, a keeping unit 10, etc. The printer 1 is mainly used in a position with the lid unit 3 facing upward as shown in FIG. 1 or a position with the surface on the near side in FIG. 1 facing upward.

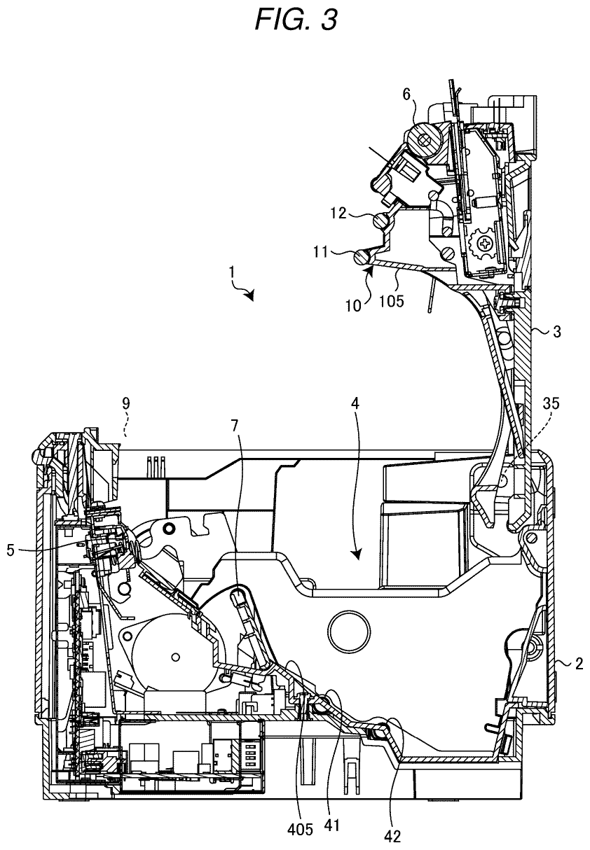

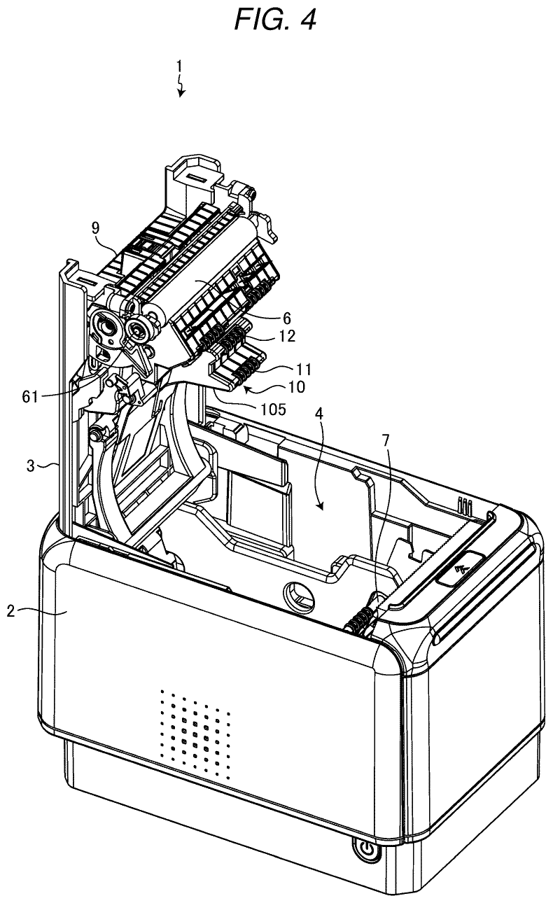

FIG. 3 is a sectional view showing the printer 1 with the lid unit 3 open. FIG. 4 is a perspective view showing the printer 1 with the lid unit 3 open.

The housing 2 is a container having an opening portion opened and closed by the lid unit 3. The lid unit 3 is attached to an end of the opening portion of the housing 2 pivotably around a shaft 35 provided in one end part and moves between a position in which the opening portion of the housing 2 is closed (closed position) and a position in which the opening portion is opened (opened position) with pivot. When the lid unit 3 is located in the closed position, a paper ejection opening 9 is formed between the other end part (an end part opposite to the one end part) of the lid unit 3 and the housing 2.

The holder unit 4 holds and positions a roll of paper in a width direction thereof. The roll of paper is a roll of a belt-like sheet. The sheet includes common paper such as receipt paper, labels having predetermined dimensions adhered to a belt-like backing paper, and a belt-like label without liner (linerless label). Note that the label has an adhesive agent layer (adhesive layer) provided on one side of a sheet (a back surface of a printing surface). The sheet may be a plastic film or the like in place of paper.

The printing head 5 is for printing on a sheet nipped between the platen roller 6 and itself, e.g., a line thermal head in which many heating elements are arranged along a sheet width direction. The platen roller 6 is an example of elements forming a conveyance unit, a cylindrical roller having elasticity in a surface thereof, and rotationally driven around a shaft 61 when subjected to a drive force of a motor or the like and coveys the sheet nipped between the printing head 5 and itself.

The printing head 5 is provided within the housing 2, the platen roller 6 is attached to the lid unit 3, and the printing head 5 and the platen roller 6 move closer to and away from each other with the pivotal movement of the lid unit 3. Further, when the printing head 5 and the platen roller 6 move away from each other, a sheet conveyance path is opened.

The cutter unit 8 is attached to the lid unit 3 and provided downstream of the printing head 5 and the platen roller 6 in a sheet conveyance direction, and cuts the printed sheet.

The cutter unit 8 has e.g. a fixed blade and a movable blade. The fixed blade and the movable blade are placed with cutting edges opposed to each other and the sheet conveyance path in between in a sheet thickness direction. The fixed blade is fixed within the housing 2. The movable blade is attached to the lid unit 3 and moves in directions closer to or away from the fixed blade when subjected to a drive force. The cutting edge of the movable blade slides with the cutting edge of the fixed blade, and thereby, the sheet nipped therebetween is cut.

In the printer 1 having the above described configuration, the lid unit 3 is opened and the roll of paper is held in the holder unit 4 within the housing 2, the sheet pulled out from the roll of paper is positioned to be nipped between the printing head 5 and the platen roller 6, and the lid unit 3 is closed. Thereby, a status in which the printer 1 is operable, i.e., a printable status is caused.

The printer 1 in operation performs printing on a sheet by driving the printing head 5 while conveying the sheet nipped between the printing head 5 and the platen roller 6 by rotationally driving the platen roller 6. Further, the printer 1 controls the cutter unit 8 to cut the sheet in an appropriate position. More specifically, the printer performs drive control to move the movable blade.

When the sheet is a linerless label, the printer 1 waits for removal of the cut sheet from the ejection opening 9 at each time when the cutter unit 8 cuts the sheet and, after the removal, performs the next printing. To control this, the printer 1 includes a sensor for sensing presence or absence of the sheet in the ejection opening 9. In the printer 1 using the linerless label, printing can be performed if the sensor senses no sheet.

The damper 7 has one side of a plate-like member pivotably attached to a position downstream of a pressing surface 405 of the holder unit 4 in the sheet conveyance direction and an opposite side swinging in the sheet conveyance path. The damper 7 is urged by an urging member in a direction in which the sheet conveyance path is longer, and pivots against the urge if a tension of the sheet is higher and pivots in a direction of return to the original position according to the urge if the tension of the sheet is lower. By the movement, the damper 7 reduces fluctuations of the tension of the sheet nipped between the printing head 5 and the platen roller 6 and relaxes a sudden impact. Further, the damper 7 absorbs fluctuations of a force necessary for sheet conveyance (conveyance force) due to the rotation of the platen roller 6. Note that the damper 7 does not necessarily have the shape shown in the embodiment as long as the shape provides the same action.

In the printer 1 printing on the roll of paper, the fluctuations (changes) of the conveyance force are often larger before and after the start of rotation of the roll of paper at the start of conveyance. The fluctuations of the conveyance force directly transferred to the position between the printing head 5 and the platen roller 6 cause degradation of printing quality. A specific example of the degradation of printing quality is that, if the roll of paper starts to rotate and the conveyance force suddenly becomes smaller, printing positions are skipped and white streaks (white lines) are produced. The above described inconvenience is avoided by provision of the damper 7 in related art.

If the sheet is the linerless label, in the roll of paper, i.e., a rolled part, the printing surface and an adhesive surface are in contact. Here, the adhesive surface is a back surface of the printing surface of the sheet with an adhesive layer provided (an adhesive agent applied) and to be peeled from an outer circumferential surface (printing surface) of the roll of paper. In the roll of paper of the linerless label, air may enter here and there between the printing surface and the adhesive surface, that is, the sheet may be peeled depending on the storage condition and the storage period.

If the sheet is the linerless label, since the sheet is conveyed while being peeled from the cylindrical outer circumferential surface of the roll of paper, the fluctuations of the conveyance force become larger than that for a label with liner or receipt paper. In addition, as described above, if air enters between the printing surface and the adhesive surface, the conveyance force tends to be disturbed.

The holder unit 4 of the so-called drop-in type also causes fluctuations of the conveyance force (the force necessary for sheet conveyance). If the holder unit 4 has a shaft holding the hollow part of the roll of paper, the position of the roll of paper is generally restricted when the sheet is conveyed and the conveyance force is hard to be disturbed. If the holder unit is of the drop-in type, the roll of paper moves within the holder unit 4 with the conveyance of the sheet, the conveyance force tends to be disturbed.

As described above, for the linerless label, the fluctuations of the force necessary for sheet conveyance is not completely absorbed only by the damper 7. Accordingly, the printer 1 of the embodiment further includes the keeping unit 10.

As shown in FIGS. 2 to 4, the keeping unit 10 has a shape projecting from the inner side surface of the lid unit 3. Further, the keeping unit 10 includes auxiliary rollers 11, 12. The auxiliary roller 11 is provided on an end of the projecting keeping unit 10. An end part (the opposite side to the pivoting side) of the damper 7 is located downstream of the auxiliary roller 11 in the sheet conveyance direction. The auxiliary roller 12 is located further downstream of the position of the end part of the damper 7 without tension of the sheet in the sheet conveyance direction.

The auxiliary rollers 11, 12 relax friction due to sliding with the sheet. Particularly, the auxiliary roller 11 guides the adhesive surface while avoiding adherence of the adhesive surface by rolling in contact with the adhesive surface. Further, the auxiliary roller 11 contacts an outer circumferential surface of a roll of paper 20 and suppresses friction between the roll of paper 20 and a pressing surface 105.

The holder unit 4 includes auxiliary rollers 41, 42. The auxiliary rollers 41, 42 contact the outer circumferential surface of the roll of paper 20 and suppress friction between the roll of paper 20 and the holder unit 4.

The pressing surface 405 is located in a position facing the end part of the keeping unit 10. The pressing surface 405 is a part near the printing head 5 or the like of the inner surface of the holder unit 4 holding the sheet and presses the outer circumferential surface of the roll of paper. The keeping unit 10 has the pressing surface 105 forming a pair with the pressing surface 405. The pressing surface 105 is a surface of the keeping unit 10 facing the holder unit 4 side and presses the outer circumferential surface of the roll of paper like the pressing surface 405. These pressing surfaces 105, 405 press the outer circumferential surface of the roll of paper from opposite sides to each other with the sheet conveyance path in between.

The damper 7 is located downstream of the position where the pressing surfaces 105, 405 are opposed in the sheet conveyance direction. In other words, the end part of the keeping unit 10 is located in a position upstream of the damper 7 in the sheet conveyance direction. Thereby, the roll of paper pulled toward the printing head 5 side with sheet conveyance is not in direct contact with the damper 7.

Note that the printer 1 supports three types of sheet widths (e.g., 80, 59, 40 [mm]) and can print using these. In the printer 1, a position in contact with all sheet widths of rolls of paper is a center part in the sheet width direction. Accordingly, as shown in FIG. 4, the keeping unit 10 is provided in the center part in the sheet width direction. Thereby, the keeping unit 10 can adapt to the types of sheets supported by the printer 1. If the printer 1 supports only one type of sheet width, the keeping unit 10 over the entire width of the sheet is used more preferably for effectiveness.

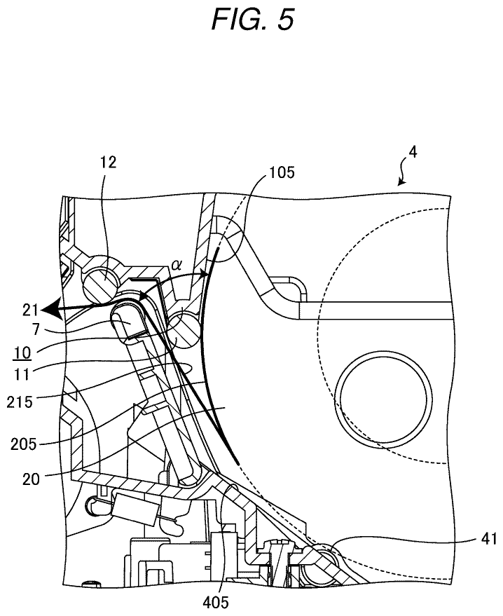

FIG. 5 is a diagram for explanation of a relation between a peeling edge of a sheet 21 from the roll of paper 20 and the keeping unit 10. A printing surface 205 is an example of the outer circumferential surface of the roll of paper 20, and faces the printing head 5 to be printed. An adhesive surface 215 is a back surface of the printing surface 205 provided with an adhesive layer (applied with an adhesive agent) and to be peeled from the outer circumferential surface of the roll of paper (printing surface 205).

A peeling edge (a part from which peeling is started) between the printing surface 205 and the adhesive surface 215 is an example of a separation edge (a part from which separation is started) between the outer circumferential surface of the roll of paper and the sheet pulled out from the roll of paper. The keeping unit 10 enters between the outer circumferential surface of the roll of paper with the rolled sheet 21 as the linerless label (printing surface 205) and the back surface of the sheet 21 (adhesive surface 215), and thereby, keeps the peeling edge at which the adhesive surface 215 is peeled from the printing surface 205 substantially constant. More specifically, the keeping unit 10 keeps an angle α of the peeling edge at a predetermined acute angle. For example, the angle α is about 28 degrees. The angle α is an example and may be different in practice.

The inventors changed the above described acute angle α to a variety of angles and verified. According to the verification, it is preferable that the angle α is smaller for suppression of the fluctuations of the conveyance force, however, reduction of the angle α to be too small causes inconvenience that, for example, if a label with liner is used as the sheet, the label is separated from the liner. In light of the inconvenience, the inventors set the above described acute angle α to e.g., 28 degrees. An optimal value of the angle α differs depending on the type and the adhesion of the sheet to be used. Accordingly, if the printer 1 supports various types of sheets, it is preferable to set the angle α at which the sheets are acceptable.

Further, the keeping unit 10 is provided to project, and the path of the conveyed sheet 21 is narrowed. Thereby, the motion of the conveyed sheet 21 may be suppressed and the motion of the sheet 21 can be restricted within the scope of the assumption.

Note that, for verification, it is preferable to form the keeping unit 10 suitable for a roll of paper having the maximum diameter to the middle diameter held in the holder unit 4. The roll of paper having a diameter less than the middle diameter has a lighter weight and, if the roll rattles within the holder unit 4, the rattling does not largely affect the printing quality.

In the printer 1 having the above described configuration, the auxiliary roller 11 in the end part of the keeping unit 10 is inserted into the separation edge between the roll of paper 20 held in the holder unit 4 and the sheet 21. Thereby, if the sheet 21 is a linerless label, the angle α at the peeling edge is kept at a predetermined acute angle (e.g., about 28 degrees). Thereby, the motion when the adhesive surface 215 is peeled from the printing surface 205 as the outer circumferential surface of the roll of paper 20 becomes stable and the force necessary for pulling out the sheet 21 (conveyance force) becomes stable. Further, thereby, degradation of the printing quality due to disturbed conveyance force may be prevented and stable printing quality may be obtained.

Further, the keeping unit 10 prevents the damper 7 from pushing the roll of paper 20, and therefore, the function of the damper 7 is not impaired by the roll of paper 20, the function of the damper 7 is sufficiently implemented, and desirable effects may be obtained.

The above described embodiment can be appropriately modified and implemented by alterations of part of configurations or functions of the above described respective devices.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer, comprising:
a holder configured to hold a roll of paper with a rolled belt-like sheet;
a conveyance component configured to pull out the sheet from the holder; and
a keeping component provided between the holder and the conveyance component and configured to keep an angle of a separation edge between a cylindrical outer circumferential surface of the roll of paper and the sheet pulled out from the roll of paper at a predetermined acute angle.

2. The printer according to claim 1, wherein
the keeping component has a projecting shape that presses the outer circumferential surface of the roll of paper and enters between the outer circumferential surface and the sheet at the separation edge, and includes a roller that rolls in contact with the sheet in an end part of the projecting shape.

3. The printer according to claim 2, wherein
the holder has a pressing surface that presses the outer circumferential surface of the roll of paper pressed by the projecting shape in a position opposed to the end part of the projecting shape.

4. The printer according to claim 3, further comprising:
a damper that absorbs fluctuations of a force necessary for conveyance of the sheet by the conveyance component is provided downstream of a position of the pressing surface to which the end part of the projecting shape is opposed.

5. The printer according to claim 4, wherein
the damper is configured to be urged by an urging member in a direction in which a sheet conveyance path is longer, and the damper is configured to pivot against the urge if a tension of the sheet increases and pivot in a direction of return to an original position of the urge if the tension of the sheet decreases.

6. The printer according to claim 1, wherein
the conveyance component includes a platen roller that nips a sheet between a printing head printing on a belt-like sheet and itself and is rotationally driven to convey the sheet away from the roll of paper.

7. The printer according to claim 1, further comprising:
a sensor for sensing presence or absence of the sheet in an ejection opening.

8. A method for a printer, comprising:
holding a roll of paper with a rolled belt-like sheet on a holder;
pulling out the sheet from the holder using a conveyance component; and
keeping an angle of a separation edge between a cylindrical outer circumferential surface of the roll of paper and the sheet pulled out from the roll of paper at a predetermined acute angle.

9. The method according to claim 8, further comprising:
the keeping component has a projecting shape that presses the outer circumferential surface of the roll of paper and enters between the outer circumferential surface and the sheet at the separation edge, and includes a roller that rolls in contact with the sheet in an end part of the projecting shape.

10. The method according to claim 9, further comprising:
the holder has a pressing surface that presses the outer circumferential surface of the roll of paper pressed by the projecting shape in a position opposed to the end part of the projecting shape.

11. The method according to claim 10, further comprising:
a damper that absorbs fluctuations of a force necessary for conveyance of the sheet by the conveyance component is provided downstream of a position of the pressing surface to which the end part of the projecting shape is opposed.

12. The method according to claim 11, further comprising:
urging the damper by an urging member in a direction in which a sheet conveyance path is longer;
pivoting the damper against the urging if a tension of the sheet increases; and
pivoting the damper in a direction of return to an original position of urging if the tension of the sheet decreases.

13. The method printer according to claim 8, further comprising:
sensing presence or absence of the sheet in an ejection opening.

14. A thermal printer, comprising:
a thermal print head;
a holder configured to hold a roll of paper with a rolled belt-like sheet;
a conveyance component configured to pull out the sheet from the holder; and
a keeping component provided between the holder and the conveyance component and configured to keep an angle of a separation edge between a cylindrical outer circumferential surface of the roll of paper and the sheet pulled out from the roll of paper at a predetermined acute angle.

15. The thermal printer according to claim 14, wherein
the keeping component has a projecting shape that presses the outer circumferential surface of the roll of paper and enters between the outer circumferential surface and the sheet at the separation edge, and includes a roller that rolls in contact with the sheet in an end part of the projecting shape.

16. The thermal printer according to claim 15, wherein
the holder has a pressing surface that presses the outer circumferential surface of the roll of paper pressed by the projecting shape in a position opposed to the end part of the projecting shape.

17. The thermal printer according to claim 16, further comprising:
a damper that absorbs fluctuations of a force necessary for conveyance of the sheet by the conveyance component is provided downstream of a position of the pressing surface to which the end part of the projecting shape is opposed.

18. The thermal printer according to claim 17, wherein
the damper is configured to be urged by an urging member in a direction in which a sheet conveyance path is longer, and the damper is configured to pivot against the urge if a tension of the sheet increases and pivot in a direction of return to an original position of the urge if the tension of the sheet decreases.

19. The thermal printer according to claim 14, wherein
the conveyance component includes a platen roller that nips a sheet between the thermal print head printing on a belt-like sheet and itself and is rotationally driven to convey the sheet away from the roll of paper.

20. The thermal printer according to claim 14, further comprising:
a sensor for sensing presence or absence of the sheet in an ejection opening.
